(19) United States
(12) Patent Application Publication
(10) Pub. No.: US 2007/0107194 A1
(43) Pub. Date: May 17, 2007

(54) Method for manufacturing rotary drum for drum washing machine and pressing device therefor

(75) Inventors: Eui Soo Kim, Suwon-si (KR); Hyung Gyoon Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/439,347

(22) Filed: May 24, 2006

(30) Foreign Application Priority Data
Nov. 7, 2005 (KR) 2005-105992

(51) Int. Cl. B23P 11/00

(52) U.S. Cl. 29/505

(57) ABSTRACT

A method for manufacturing a rotary drum for a drum washing machine, in which the strength of a bonding part of the rotary drum is improved so that the bonding part is not deformed even when the rotary drum is rotated at a high speed, and a pressing device used therefor. The method includes bending one circumferential end of the processed material in a U shape to form a first overlapping part and a first bending part, and bending the other circumferential end of the processed material in a U shape to form a second overlapping part and a second bending part; overlapping the first and second overlapping parts with each other to form a connection part; and pressing the connection part so that the original shapes of the first and second bending parts are maintained and the first and second overlapping parts are adhered to each other to form a bonding part. The pressing of the connection part is achieved by a press die including upper and lower dies respectively having a plurality of first and second protrusions disposed in the forward and backward direction of the connection part and having designated spaces between lower ends of the first protrusions and the lower die and/or between upper ends of the second protrusions and the upper die when the upper and lower dies contact each other.

### CROSS-REFERENCE TO RELATED APPLICATIONS

This application claims the benefit of Korean Patent Application No. 2005-0105992, filed Nov. 7, 2005, in the Korean Intellectual Property Office, the disclosure of which is incorporated herein by reference.

### BACKGROUND OF THE INVENTION

1. Field of the Invention

The present invention relates to a method for manufacturing a rotary drum for a drum washing machine, and more particularly, to a method for manufacturing a rotary drum for a drum washing machine in which the strength at a bonding part of the rotary drum is improved so that the bonding part is not deformed even when the rotary drum is rotated at a high speed, and a pressing device used therefor.

2. Description of the Related Art

Generally, washing machines, which wash laundry using electric power, are divided into a vertical shaft drum washing machine, in which a washing tub is vertically installed in a main body, and a drum washing machine, in which a washing tub is horizontally installed in a main body. The drum washing machine vertically moves the laundry together with washing water along the inner circumferential surface of a washing tub, i.e., a rotary drum, which is vertically installed, by the alternate rotations of the rotary drum in the clockwise and counterclockwise directions, thereby washing the laundry.

Generally, a rotary drum for a drum washing machine includes a cylindrical portion for forming the circumferential surface thereof, and front and rear portions connected to front and rear ends of the cylindrical portion for forming the front and rear surfaces thereof. The cylindrical portion is formed by roll-forming a flat plate member and by bonding both circumferential ends of the rolled plate.

In the above process of forming the cylindrical portion, the bonding of both circumferential ends of the rolled plate member is achieved by mechanical pressing using seaming and by welding. The bonding of the ends of the plate member by welding is advantageous in that a connection part maintains high strength. However, considering the rotary drum is used in an environment where it is exposed to water for an extended period of time, a welding part is likely to be damaged and caused to rust and rust stains soak through and damage laundry. Further, a welding process deteriorates efficiency of manufacturing the rotary drum.

The bonding of the ends of the plate member by mechanical pressing does not cause the above problems, and is advantageous in that the fatigue strength at the bonding part formed by mechanical pressing is higher than the fatigue strength at the bonding part formed by welding. Further, the bonding by mechanical pressing does not consume a separate material except for the pressing die, thereby reducing production costs of the rotary drum compared to the bonding by welding.

When the bonding by mechanical pressing is conventionally performed, both circumference ends of a material are bent and are engaged with each other so as to form a joint part, and the joint part is pressed so that contact areas between the overlapped portions of the ends are increased and the strength at the obtained bonding part is maintained. In the above conventional mechanical pressing method, when the joint part is pressed, sharply bending parts are obtained and fatigue due to plastic deformation is accumulated on the bending parts, thereby reducing the bonding strength of the bonding part.

Recently, a rotary drum suitable for use in high-speed dehydration has been researched. In the above rotary drum suitable for use in high-speed dehydration, strong tensile force due to the rotation of the rotary drum at a high speed is applied to a bonding part of the rotary drum. Accordingly, when the bonding part does not maintain sufficient bonding strength, the bonding part is deformed or damaged. Thus, it is difficult to apply the conventional mechanical pressing method, causing low bonding strength, to a rotary drum suitable for use in high-speed dehydration. However, since the mechanical pressing method has many advantages compared to the welding method, if the bonding strength problem of the mechanical pressing method is solved, a rotary drum for use in high-speed dehydration can employ the mechanical pressing method.

### SUMMARY OF THE INVENTION

Therefore, one aspect of the invention is to provide a method for manufacturing a rotary drum for a drum washing machine, which is suitable for high-speed rotation, using a mechanical pressing technique, and a pressing device used therefor.

In accordance with one aspect, the present invention provides a method for manufacturing a rotary drum for a drum washing machine, in which a cylindrical portion of the rotary drum is formed by bonding both circumferential ends of a cylindrical processed material, including: bending one circumferential end of the processed material in a U shape to form a first overlapping part and a first bending part, and bending the other circumferential end of the processed material in a U shape to form a second overlapping part and a second bending part; overlapping the first and second overlapping parts with each other to form a connection part; and pressing the connection part so that the original shapes of the first and second bending parts are maintained and the first and second overlapping parts are adhered to each other to form a bonding part. When the original shapes of the first and second bending parts are maintained during the pressing of the connection part as described above, fatigue due to plastic deformation is not accumulated on the first and second bending parts, thereby improving the bonding strength of the rotary drum.

The pressing of the connection part may be achieved by a press die including upper and lower dies respectively having a plurality of first and second protrusions disposed in the forward and backward direction of the connection part and having designated spaces between lower ends of the first protrusions and the lower die and/or between upper ends of the second protrusions and the upper die when the upper and lower dies contact each other.

The first and second bending parts may have a radius of curvature of 0.5 mm, and the first and second overlapping parts may have a length of 3-6 mm.

Further, the first and second protrusions may have a height of 2.5-3 mm, and a thickness of 1.2 mm.

The lower ends of the first protrusions may respectively have planes downwardly inclined in the leftward or rightward direction, and the upper ends of the second protrusions may respectively have planes downwardly inclined in the same direction of the inclined plane of the lower ends of the first protrusions.

In accordance with another aspect, the present invention provides a method for manufacturing a rotary drum for a drum washing machine, in which a cylindrical portion of the rotary drum is formed by bonding both circumferential ends of a cylindrical processed material, including: bending one circumferential end of the processed material in a U shape to form a first overlapping part and a first bending part, and bending the other circumferential end of the processed material in a U shape to form a second overlapping part and a second bending part; overlapping the first and second overlapping parts with each other to form a connection part; and pressing the connection part into a corrugated shape by upper and lower dies disposed above and below the connection part, wherein the highest points of the connection part in the corrugated shape do not contact the upper die and the lowest points of the connection part in the corrugated shape do not contact the lower die when the connection part is maximally pressed in the pressing of the connection part.

In accordance with another aspect, the present invention provides a pressing device having upper and lower dies for pressing a connection part of a cylindrical processed material disposed between the upper and lower dies to form a cylindrical portion of a rotary drum for a drum washing machine, including: a plurality of first protrusions protruded downwardly from the upper die and disposed in the longitudinal direction of the connection part, and a plurality of second protrusions protruded upwardly from the lower die and entering between the first protrusions in the pressing of the connection part for deforming the connection part into a corrugated shape; and designated spaces formed between lower ends of the first protrusions and the lower die and/or between upper ends of the second protrusions and the upper die when the upper and lower dies contact each other.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a longitudinal sectional view of a rotary drum obtained by a method for manufacturing a rotary drum for a drum washing machine in accordance with the present invention;

FIG. 2 is a flow chart illustrating the method for manufacturing the rotary drum in accordance with the present invention;

FIGS. 3 and 4 are views respectively illustrating bending and overlapping steps of a process for manufacturing a cylindrical portion in the method of the present invention;

FIGS. 5 to 7 are views illustrating a pressing step of the process for manufacturing the cylindrical portion in the method of the present invention; and

FIG. 8 is a table showing test results of a tensile strength of the rotary drum manufactured by the method of the present invention.

### DETAILED DESCRIPTION OF THE PREFERRED EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the annexed drawings.

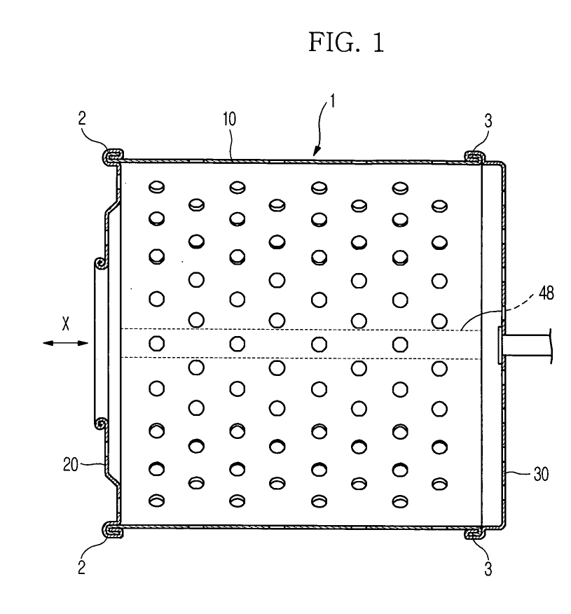

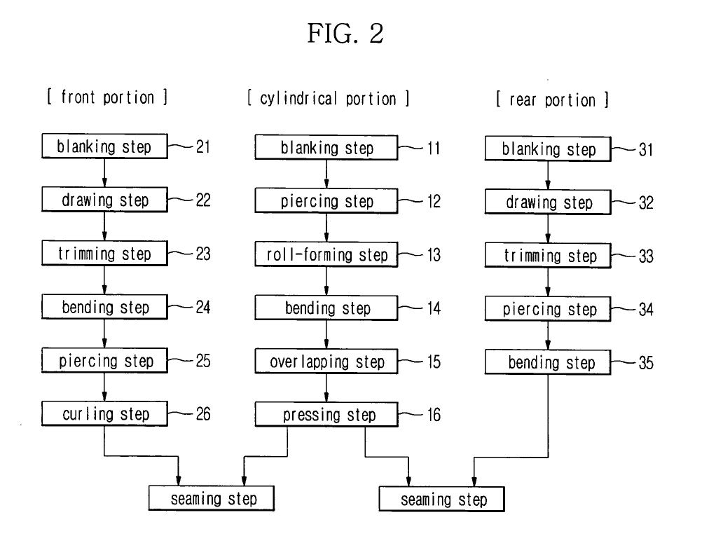

FIG. 1 is a longitudinal sectional view of a rotary drum obtained by a method for manufacturing a rotary drum for a drum washing machine in accordance with the present invention, and FIG. 2 is a flow chart illustrating the method for manufacturing the rotary drum in accordance with the present invention.

As shown in FIG. 1, the rotary drum 1 obtained by the method of the present invention includes a cylindrical portion 10, and front and rear portions 20 and 30 connected to front and rear ends of the cylindrical portion 10. The cylindrical portion 10, the front portion 20, and the rear portion 30 are separately molded, and are then bonded by a seaming step. Reference numerals 2 and 3 of FIG. 1 represent seaming parts obtained by bonding the front and rear portions 20 and 30 to the cylindrical portion 10.

With reference to FIG. 2, a process for manufacturing the front portion 20 and the rear portion 30 will be described, as below. The front portion 20 is molded by a blanking step 21 in which a plate member having a circular shape is punched out of a raw material using a punch and a die, a drawing step 22 in which the plate member is curved, a trimming step 23 in which unnecessary parts are cut off from the plate member, a bending step 24 in which the circumference of the plate member is bent to be connected to the cylindrical portion 10, a piercing step 25 in which several holes are formed through the plate member, and a curling step 26 in which a part of the front portion 20 corresponding to the circumference of an opening, through which laundry is put into the drum, is curled. Further, the rear portion 30 is molded by a series of steps similar to that of the front portion 20, i.e., a blanking step 31, a drawing step 32, a trimming step 33, a piercing step 34, and a bending step 35.

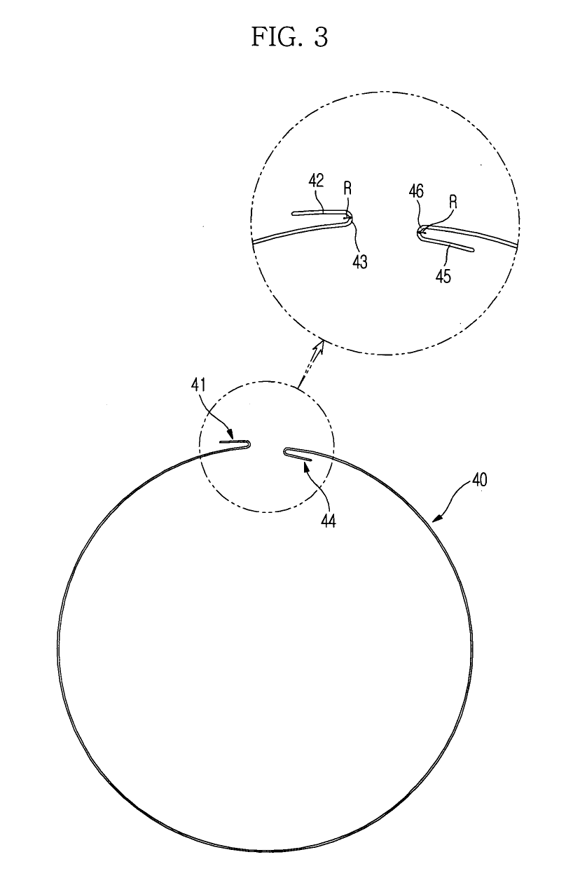

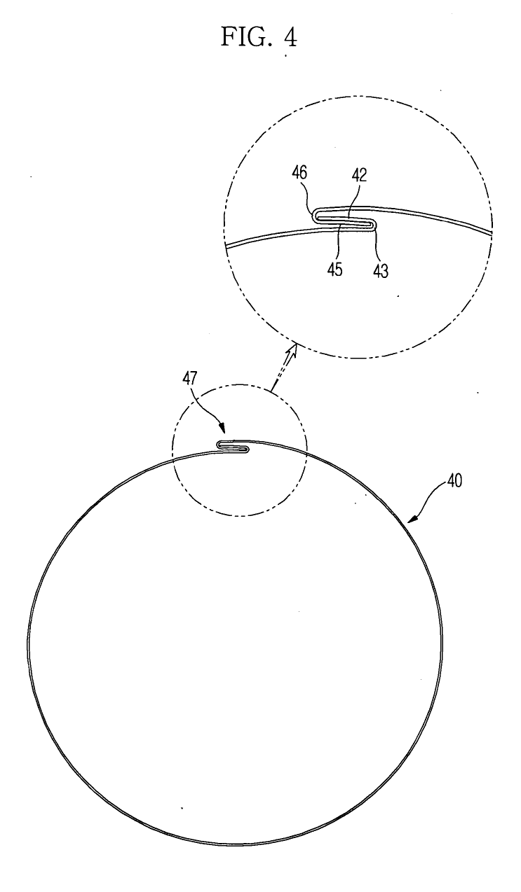

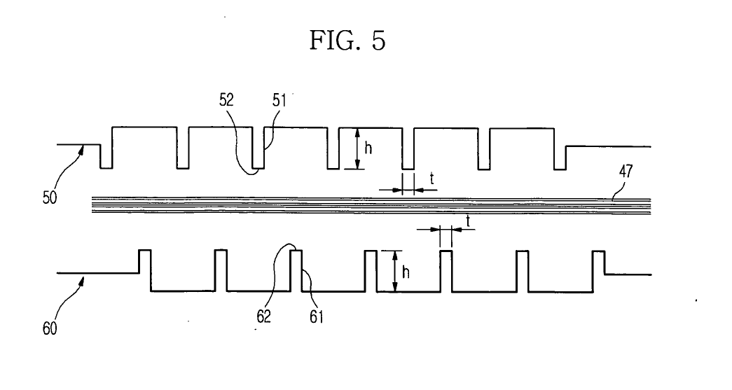

FIGS. 3 and 4 are views respectively illustrating bending and overlapping steps of a process for manufacturing a cylindrical portion in the method of the present invention, and FIGS. 5 to 7 are views illustrating a pressing step of the process for manufacturing the cylindrical portion in the method of the present invention. Hereinafter, with reference to FIGS. 2 to 7, the process for manufacturing the cylindrical portion 10 will be described.

A cylindrical processed material 40, both circumferential ends of which are not connected to each other, is formed by a blanking step 11 in which a plate member having a rectangular shape is punched out of a raw material, a piercing step 12 in which dehydration holes for dehydrating laundry therethrough are formed through the plate member, and a roll-forming step 13 in which the plate member having the rectangular plate shape is converted into a cylindrical shape by passing through a gap between rollers. Then, the cylindrical portion 10 of a rotary drum 1 is completely manufactured from the above processed material 40 by a bending step 14, an overlapping step 15, and a pressing step 16.

As shown in FIG. 3, in the bending step 14, one circumferential end 41 of the processed material 40 is bent in a U shape in one direction so that a first overlapping part 42 and a first bending part 43 are formed, and the other circumferential end 44 of the processed material 40 is bent in a U shape in the opposite direction so that a second overlapping part 45 and a second bending part 46 are formed. The first overlapping part 42 and the second overlapping part 45 may have a length of approximately 3-6 mm. In FIG. 3, the circumferential end 41 of the processed material 40 is bent upwardly, and the circumferential end 44 of the processed material 40 is bent downwardly.

In order to prevent the accumulation of fatigue onto the first bending portion 43 and the second bending portion 46 due to the sharp bending of the first bending portion 43 and the second bending portion 46, a U-shaped bending method is employed. The first bending portion 43 and the second bending portion 46 may have a radius of curvature (R) of approximately 0.5 mm. When the radius of curvature (R) of the first and second bending portions 43 and 46 is excessively small, the first and second bending portions 43 and 46 have an approximately V shape and fatigue is accumulated onto the first and second bending portions 43 and 46. On the other hand, when the radius of curvature (R) of the first and second bending portions 43 and 46 is excessively large, the first and second bending portions 43 and 46 contact a pressing die in the pressing step 16 and are pressed by the pressing die, and thus fatigue caused by plastic deformation is accumulated onto the first and second bending portions 43 and 46.

As shown in FIG. 4, after the bending step 14, the overlapping step 15 in which the first overlapping part 42 and the second overlapping part 45 are overlapped with each other so as to form a connection part 47 is performed. In the overlapping step 15, both ends of the cylindrical processed material 40 are temporarily overlapped with each other. After the overlapping step 15, the pressing step 16 in which the connection part 47 is firmly pressed to form a bonding part 48 (with reference to FIG. 1) is performed. Here, the connection part 47 and the bonding part 48 essentially designate the same part, but are distinguished from each other in that the bonding part 48 is obtained after the pressing step 16.

In order to improve the bonding strength when two materials are bonded by a pressing step, it is important to increase dimensions of contact portions of the two materials by applying proper molding pressure to the materials. In the drum washing machine, strong tensile force is generated by the rotation of the rotary drum 1 at a high speed and load is concentrated onto the first bending part 43 and the second bending part 46, thereby spreading the first and second bending parts 43 and 46 and releasing the bonding between the first and second bending parts 43 and 46. Thus, it is more important to prevent fatigue from being accumulated onto the first and second bending parts 43 and 46 and to protect the first and second bending parts 43 and 46 so that residual stress due to plastic deformation not occurs in the first and second bending parts 43 and 46.

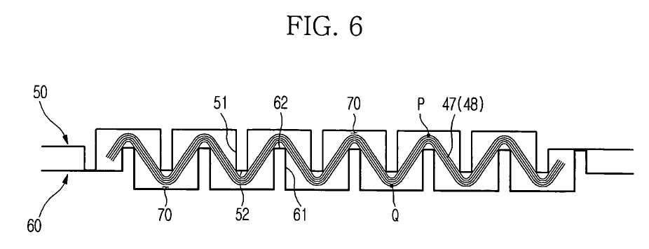

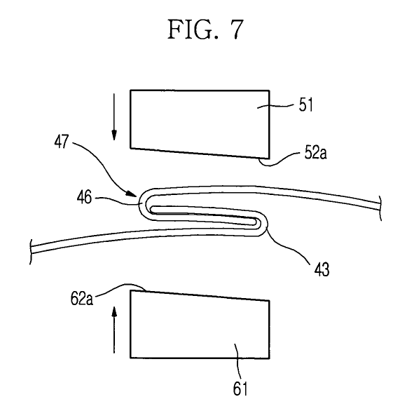

Accordingly, in the present invention, the pressing step 16 is performed using a press die, which is designed such that fatigue due to press is scarcely accumulated onto the first and second bending portions 43 and 46. FIG. 5 is a sectional view of the press die taken along the longitudinal direction of the connection part (in the X-direction of FIG. 1) illustrating a state in which the connection part is pressed between upper and lower dies, FIG. 6 is a sectional view of the press die illustrating a state in which the pressing of the connection part is completed, and FIG. 7 is a sectional view of the press die taken along the circumferential direction of the rotary drum illustrating a state in which the connection part is pressed between first protrusions and second protrusions. Although FIG. 7 illustrated that the first protrusions and the second protrusions are positioned on the same plane, the second protrusions are substantially located in front of or in the rear of the corresponding first protrusions.

As shown in FIGS. 5 and 6, the press die used in the pressing step 16 of the present invention includes an upper die 50 having a plurality of first protrusions 51 disposed in the longitudinal direction of the connection part 47 and a lower die 60 having a plurality of second protrusions 61 disposed in the longitudinal direction of the connection part 47. The first protrusions 51 are protruded downwardly from the upper die 50, and the second protrusions 61 are protruded upwardly from the lower die 60. The second protrusions 61, which alternate with the first protrusions 51, are respectively located between the first protrusions 51 in the pressing step 16, thereby deforming the connection part 47 of the processed material 40, located between the first and lower dies 50 and 60, into a corrugated shape.

The press die, which is employed by the present invention, is configured such that designated spaces 70 are formed between lower ends 52 of the first protrusions 51 and the lower die 60 and between upper ends 62 of the second protrusions 61 and the upper die 50 when the upper and lower dies 50 and 60 contact each other under the condition that any processed material is not located between the upper and lower dies 50 and 60. Through the above configuration of the press die, the highest points (P) and the lowest points (Q) of the connection part 47 do not contact the upper and lower dies 50 and 60 when the first and second overlapping parts 42 and 45 are pressed into the corrugated shape, thereby allowing the first and second bending parts 43 and 46 to maintain their original shapes. That is, these spaces 70 prevent the upper and lower dies 50 and 60 from completely contacting each other in the pressing step, thus preventing the first and second bending parts 43 and 46 from being sharply plastically deformed. Although this embodiment describes the spaces 70 existing between the lower ends 52 of the first protrusions 51 and the lower die 60 and between the upper ends 62 of the second protrusions 61 and the upper die 50, the spaces 70 may exist only between the lower ends 52 of the first protrusions 51 and the lower die 60 or only between the upper ends 62 of the second protrusions 61 and the upper die 50.

When the spaces 70 exists between the upper and lower dies 50 and 60 as described above, pressure applied to the connection part 47 is reduced. Accordingly, in order to compensate for the reduction in the above pressure applied to the connection part 47, the first and second protrusions 51 and 61 may have a height (h) of approximately 2.5-3 mm and a thickness (t) of approximately 1.2 mm.

As shown in FIG. 7, the lower ends 52 of the first protrusions 51 and the upper ends 62 of the second protrusions 61 respectively may have incline planes 52a and 62a, which are downwardly inclined in the rightward direction. The incline planes 52a and 62a allow the first and second bending portions 43 and 46, on which load caused by the rotation of the rotary drum is concentrated, to be pressed by pressure higher than pressure applied to other portions of the connection part 47. Thereby, the first and second bending parts 43 and 46 are protected by the spaces 70 formed between the lower ends 52 of the first protrusions 51 and the lower die 60 and between the upper ends 62 of the second protrusions 61 and the upper die 50 so that fatigue accumulated on the first and second bending parts 43 and 46 is minimized, and proper pressure is applied to the first and second bending parts 43 and 46 so that the strength of the connection part 47 is improved. Here, the incline planes 52a and 62a may be downwardly inclined in the leftward direction.

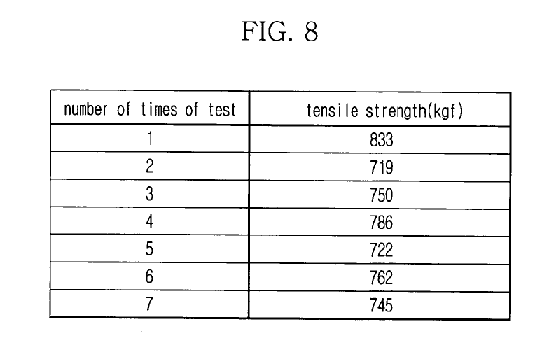

FIG. 8 is a table showing test results of a tensile strength of the rotary drum manufactured by the method of the present invention. As shown in FIG. 8, the rotary drum manufactured by the method of the present invention has a bonding strength of 760 kgf on the average. Considering that the bonding strength of the rotary drum used in a high-speed dehydration mode is 450 kgf, the rotary drum manufactured by the method of the present invention is suitable for use in the high-speed dehydration mode.

As apparent from the above description, the present invention provides a method for manufacturing a rotary drum for a drum washing machine, which is suitable for high-speed rotation, using a mechanical press bonding technique, and a pressing device used therefor. That is, since a connection part of the rotary drum is not deformed and damaged when the rotary drum is rotated at a high speed, the method of the present invention improves the reliability of the rotary drum, and has improved productivity compared to a method, in which both ends of a cylindrical portion are bonded by welding.

Although an embodiment of the invention has been shown and described, it would be appreciated by those skilled in the art that changes may be made in this embodiment without departing from the principles and spirit of the invention, the scope of which is defined in the claims and their equivalents.

What is claimed is:

1. A method for manufacturing a rotary drum for a drum washing machine, in which a cylindrical portion of the rotary drum is formed by bonding both circumferential ends of a cylindrical processed material, comprising:
bending one circumferential end of the processed material in a U shape to form a first overlapping part and a first bending part, and bending the other circumferential end of the processed material in a U shape to form a second overlapping part and a second bending part;
overlapping the first and second overlapping parts with each other to form a connection part; and
pressing the connection part so that the original shapes of the first and second bending parts are maintained and the first and second overlapping parts are adhered to each other to form a bonding part.

2. The method as set forth in claim 1, wherein the pressing of the connection part is achieved by a press die comprising upper and lower dies respectively having a plurality of first and second protrusions disposed in the forward and backward direction of the connection part and having designated spaces between lower ends of the first protrusions and the lower die and/or between upper ends of the second protrusions and the upper die when the upper and lower dies contact each other.

3. The method as set forth in claim 1, wherein the first and second bending parts have a radius of curvature of 0.5 mm.

4. The method as set forth in claim 1, wherein the first and second overlapping parts have a length of 3-6 mm.

5. The method as set forth in claim 2, wherein the first and second protrusions have a height of 2.5-3 mm.

6. The method as set forth in claim 2, wherein the lower ends of the first protrusions respectively have planes downwardly inclined in the leftward or rightward direction.

7. The method as set forth in claim 6, wherein the upper ends of the second protrusions respectively have planes downwardly inclined in the same direction of the inclined plane of the lower ends of the first protrusions.

8. The method as set forth in claim 2, wherein the first and second protrusions have a thickness of 1.2 mm.

9. A method for manufacturing a rotary drum for a drum washing machine, in which a cylindrical portion of the rotary drum is formed by bonding both circumferential ends of a cylindrical processed material, comprising:
bending one circumferential end of the processed material in a U shape to form a first overlapping part and a first bending part, and bending the other circumferential end of the processed material in a U shape to form a second overlapping part and a second bending part;
overlapping the first and second overlapping parts with each other to form a connection part; and
pressing the connection part into a corrugated shape by upper and lower dies disposed above and below the connection part,
wherein the highest points of the connection part in the corrugated shape do not contact the upper die and the lowest points of the connection part in the corrugated shape do not contact the lower die when the connection part is maximally pressed in the pressing of the connection part.

10. The method as set forth in claim 9, wherein:
the upper die has a plurality of first protrusions protruded downwardly therefrom and disposed in the longitudinal direction of the connection part, and the lower die has a plurality of second protrusions protruded upwardly therefrom and entering between the first protrusions in the pressing of the connection part; and
designated spaces are formed between lower ends of the first protrusions and the lower die and/or between upper ends of the second protrusions and the upper die 10 when the upper and lower dies contact each other.

11. The method as set forth in claim 10, wherein the lower ends of the first protrusions respectively have planes downwardly inclined in the leftward or rightward direction.

12. The method as set forth in claim 11, wherein the upper ends of the second protrusions respectively have planes downwardly inclined in the same direction of the inclined plane of the lower ends of the first protrusions.

13. A pressing device having upper and lower dies for pressing a connection part of a cylindrical processed material disposed between the upper and lower dies to form a cylindrical portion of a rotary drum for a drum washing machine, comprising:
a plurality of first protrusions protruded downwardly from the upper die and disposed in the longitudinal direction of the connection part, and a plurality of second protrusions protruded upwardly from the lower die and entering between the first protrusions in the pressing of the connection part for deforming the connection part into a corrugated shape; and
designated spaces formed between lower ends of the first protrusions and the lower die and/or between upper ends of the second protrusions and the upper die when the upper and lower dies contact each other.

14. The pressing device as set forth in claim 13, wherein the lower ends of the first protrusions respectively have planes downwardly inclined in the leftward or rightward direction.

15. The pressing device as set forth in claim 14, wherein the upper ends of the second protrusions respectively have planes downwardly inclined in the same direction of the inclined plane of the lower ends of the first protrusions.

16. The pressing device as set forth in claim 13, wherein the first and second protrusions have a height of 2.5-3 mm.

17. The pressing device as set forth in claim 13, wherein the first and second protrusions have a thickness of 1.2 mm.
